(19) United States
(12) Patent Application Publication
(10) Pub. No.: US 2006/0238699 A1
(43) Pub. Date: Oct. 26, 2006

(54) Parallax eliminator

(76) Inventor: Earlest Joel Albert Carter, Chicago, IL (US)

Correspondence Address: Earlest JA Carter, 1053 West Columbia, Chicago, IL, 60626, US

(21) Appl. No.: 11/113,734

(22) Filed: Apr. 26, 2005

(51) Int. Cl. G02C 7/00

(52) U.S. Cl. 351/53

(57) ABSTRACT

I have submitted a narrative along with marked up copies describing the Parallax Eliminator process and product and technique which produces the Parallax Eliminator Effect. I have submitted my claims along with marked up copies which are consecutively number of the process and product which produce the Parallax Eliminator Effect. I have submitted my drawing of the product and its application which produces the Parallax Elimination effect.

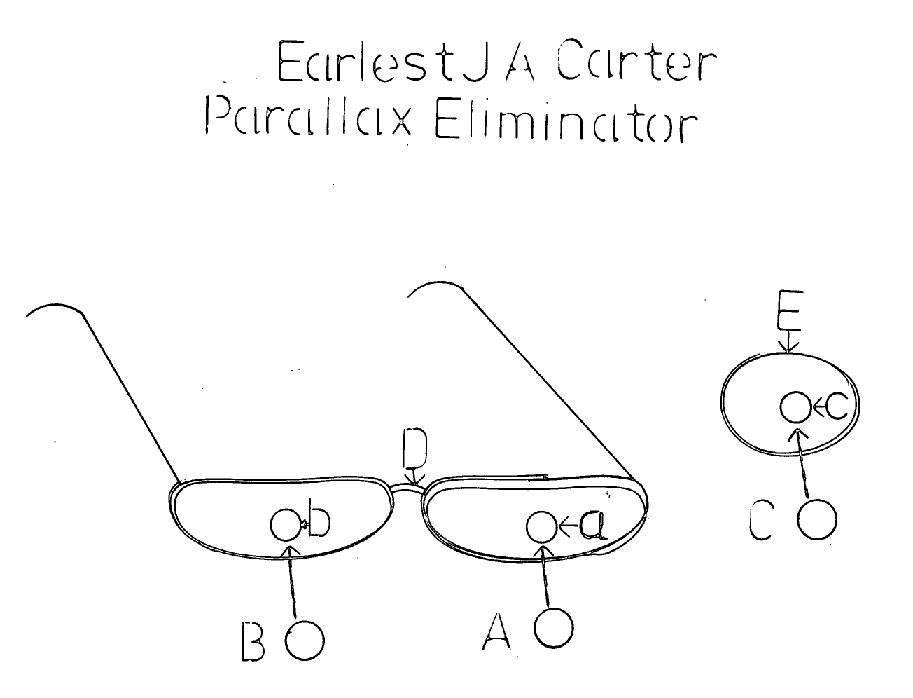

The parallax eliminator is designed to improve the aiming ability of the average shooter and help decrease the time interval between pointing and aiming of a firearm at a target.

Parallax: The apparent displacement of an observed object due to the difference between two points of view.

The parallax eliminator-eliminates the double image of a fire arm or any other object being held up in front of a shooter's face when the shooter is trying to focus on another object in the distance such as a target while keeping both eyes opened.

The parallax eliminator accomplishes the elimination of the double image of an object (such as a firearm) being held in front of a shooters face without the shooter having to close one eye (usually the none dominate one) while aiming at a target with both eyes open. The shooter is allowed to keep both eyes open and focus on the target while aiming the firearm when using the parallax eliminator.

The parallax eliminator is not like a patch; a patch will cover the entire eye of the wearer and cut off the vision in that covered eye completely. The parallax eliminator allows the wearer to see both to the front and to the side when applied.

1. I claim the development of the appliqué geometric form dimensions diameter and thickness which when applied to a lens produces the Parallax Eliminator effect.

2. I claim the development of the technique of producing the Parallax Eliminator effect by applying the process of an abrasive to lens to produce the Parallax Eliminator effect.

3. I claim the development of the use of paint or other coloring material which when applied to a lens to produce the Parallax Eliminator effect.

4. I claim the application of the aligning process of the Parallax Eliminator in all of it's forms with the pupil of the none dominate eye of the wearer of glasses (with lens) or a monocle when the technique as described is applied to the Lens of glasses or a monocle to produce the Parallax Eliminator effect.
